(19) United States
(12) Patent Application Publication
(10) Pub. No.: US 2024/0396103 A1
(43) Pub. Date: Nov. 28, 2024

(54) ENERGY STORAGE DEVICE CAPABLE OF SUPPRESSING SPREAD OF BATTERY FIRE AND CONTROL METHOD FOR THE SAME

(71) Applicant: DYNAPACK INTERNATIONAL TECHNOLOGY CORPORATION, Taoyuan City (TW)

(72) Inventors: Chung-Hsing CHANG, Taoyuan City (TW); Wen-Yi CHEN, Taoyuan City (TW); Way-Lung WU, Taoyuan City (TW); Teng-Chi HUANG, Taoyuan City (TW); Shi-Cheng TONG, Taoyuan City (TW); Yong-Han CHEN, Taoyuan City (TW); Yu-Chun WANG, Taoyuan City (TW)

(21) Appl. No.: 18/202,288

(22) Filed: May 26, 2023

(51) Int. Cl. H01M 10/44; H01M 10/42; H01M 10/48; H02J 7/34

(52) U.S. Cl. CPC H01M 10/443; H01M 10/425; H01M 10/486; H02J 7/342; H01M 2010/4271; H01M 2200/10

(57) ABSTRACT

An energy storage device capable of suppressing battery spread of battery fire includes a control module and a plurality of battery modules, and the battery modules respectively include an accommodation space, a plurality of battery packs, a plurality of temperature sensors and a controller. The controller provides a first control signal to notify the control module based on an ambient temperature detected by one of the temperature sensors being greater than or equal to a first specific temperature range. The control module is used to transfer a battery capacity of an abnormal battery module of the battery modules providing the first control signal to a backup energy storage module, and the backup energy storage module includes the battery modules except the abnormal battery module or a next-stage device.

### BACKGROUND

### Technical Field

The present disclosure relates to an energy storage device and a control method the same, and more particularly to the energy storage device capable of suppressing spread of battery fire and the control method for the same.

### Description of Related Art

Lithium batteries have been widely used in consumer 3C product, electric vehicle and Backup Battery Unit (BBU) due to their advantages of light-weight, compactness and high energy density. In recent years, the demand for battery has grown rapidly, and the application of lithium battery in Energy Storage System (ESS) has drastically changed from kilo-Watt to Mega-Watt, or Giga-Watt.

However, with the occurrence of many lithium battery fire accidents in recent years, it has been confirmed that even under multiple protections such as Battery Management System (BMS) and mechanical structure, there is still a potential risk of spontaneous combustion due to heat generation. It not only hurts the image of the company, but also affects the investment willingness and market plan of the company. Besides, it also has a serious impact on the development of the lithium battery industry.

In response to the problem of lithium battery fire accidents by the internal short-circuit, the International Electrotechnical Commission (IEC) and Underwriters Laboratories (UL) have successively formulated the test methods for internal short-circuit of battery cells and the spread of battery fire in the battery system, and then extended clear specifications and regulations, for example but not limited to, IEC-62619, UL1973, UL9540A and other related safety standards and their certification methods. The international community obviously has paid close attention to the issue of lithium battery thermal runaway and fire accidents, so the technology to prevent the spread of battery fire has also been highly valued by the industry.

On the other hand, in one example, IEC-62619, UL1973, and UL9540A define thermal runaway as a phenomenon in which the exothermic reaction inside the battery cells causes a rapid rise in temperature. As shown in FIG. 1A, in the energy storage device, since the battery pack(s) 2 (for example but not limited to, lithium battery) in the battery module 200 has high energy density and contains combustible components therein; an isolation film of the battery pack(s) 2 may be hot melting, or broken hole by internal stress due to factors such as high temperature, overcharging, impact, electronic control system error or process flaws, resulting plates of battery pack(s) 2 contact to form a short circuit and a high-temperature chemical reaction occurs. Subsequently, it usually takes some time from the abnormal temperature rise of the battery cells inside the first battery pack(s) 2 to thermal runaway, the generated high heat or flame tends to cause successive thermal runaway of the battery cells in the adjacent battery pack(s) 2, so that excessive heat is accumulated in the battery pack(s) 2 until the battery pack(s) 2 is completely burnt out. Finally, as shown in FIG. 1B, the case of the battery module 200 is broken due to its burning through by an open flame, and the flame spreads to other battery module(s) 200, so that it fails to satisfy the requirements of the above specifications.

Therefore, it is a major topic for the inventors of the present disclosure to design an energy storage device capable of suppressing spread of battery fire and a control method of suppressing spread of battery fire the same to suppress the impact caused by flame spread.

### SUMMARY

In order to solve the above-mentioned problems, the present disclosure provides an energy storage device for suppressing spread of battery fire. The energy storage device is coupled to a next-stage device, and includes a control module and a plurality of battery modules. The control module is configured to control the battery modules to provide power to the next-stage device, and the battery modules respectively includes an accommodation space, a plurality of battery packs, a plurality of temperature sensors, and a controller. The battery packs are arranged in the accommodation space and the temperature sensors are dispersedly arranged into the accommodation space, so as to respectively detect an ambient temperature around the temperature sensors. The controller is coupled to the temperature sensors, and is configured to provide a first control signal to notify the control module when the ambient temperature detected by one of the temperature sensors is greater than or equal to a first specific temperature range. The control module is configured to transfer a battery capacity of an abnormal battery module providing the first control signal to a backup energy storage module, and the backup energy storage module includes at least one battery module other than the abnormal battery module sending the first control signal, or the next-stage device.

In order to solve the above-mentioned problems, the present disclosure provides a control method of suppressing spread of battery fire. The control method is applied to an energy storage device, and the energy storage device includes a plurality of battery packs arranged in an accommodation space, a plurality of temperature sensors dispersedly arranged in the accommodation space. The control method includes steps of: determining whether an ambient temperature detected by one of the temperature sensors is greater than or equal to a first specific temperature range, and providing a first control signal to enter an energy transfer mode when the ambient temperature detected by the one of the temperature sensors is greater than or equal to the first specific temperature range, and the energy transfer mode comprising a step of: transferring a battery capacity of a battery module providing the first control signal to a backup energy storage module. Wherein the backup energy storage module comprises at least one battery module other than the battery module, or the next-stage device.

In one embodiment, the main purpose and effect of the present disclosure is that the energy storage device transfers the battery capacity of the battery module through the control module when the ambient temperature detected by the temperature sensor is greater than or equal to the first specific temperature range, so as to suppress the impact caused by the spread of the battery fire, and also ensure that the battery fire does not spread completely after thermal runaway of the battery cell and improves the safety of the battery system.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawing as follows:

FIG. 1A is a schematic diagram of the fire spread of the battery pack inside a related-art battery module.

FIG. 1B is a photo of experimental results of the battery generating an open flame through the battery fire spread test in the related art.

FIG. 2A is a block circuit diagram of an energy storage device capable of suppressing spread of battery fire of the present disclosure.

FIG. 2B is a block circuit diagram of a battery module capable of suppressing spread of battery fire of the present disclosure.

FIG. 3A is a flowchart of a control method of the battery module according to a first embodiment of the present disclosure.

FIG. 3B is a flowchart of the control method of the battery module according to a second embodiment of the present disclosure.

FIG. 4A is a flowchart of the control method for entering the energy transfer mode according to a first embodiment of the present disclosure.

FIG. 4B is a flowchart of the control method for entering the energy transfer mode according to a second embodiment of the present disclosure.

FIG. 5A is a flowchart of the control method for exiting the energy transfer mode according to a first embodiment of the present disclosure.

FIG. 5B is a flowchart of the control method for exiting the energy transfer mode according to a second embodiment of the present disclosure.

FIG. 5C is a flowchart of the control method for exiting the energy transfer mode according to a third embodiment of the present disclosure.

FIG. 6A is a transfer path diagram of the energy transfer mode according to a first embodiment of the present disclosure.

FIG. 6B is a transfer path diagram of the energy transfer mode according to a second embodiment of the present disclosure.

FIG. 6C is a transfer path diagram of the energy transfer mode according to a third embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

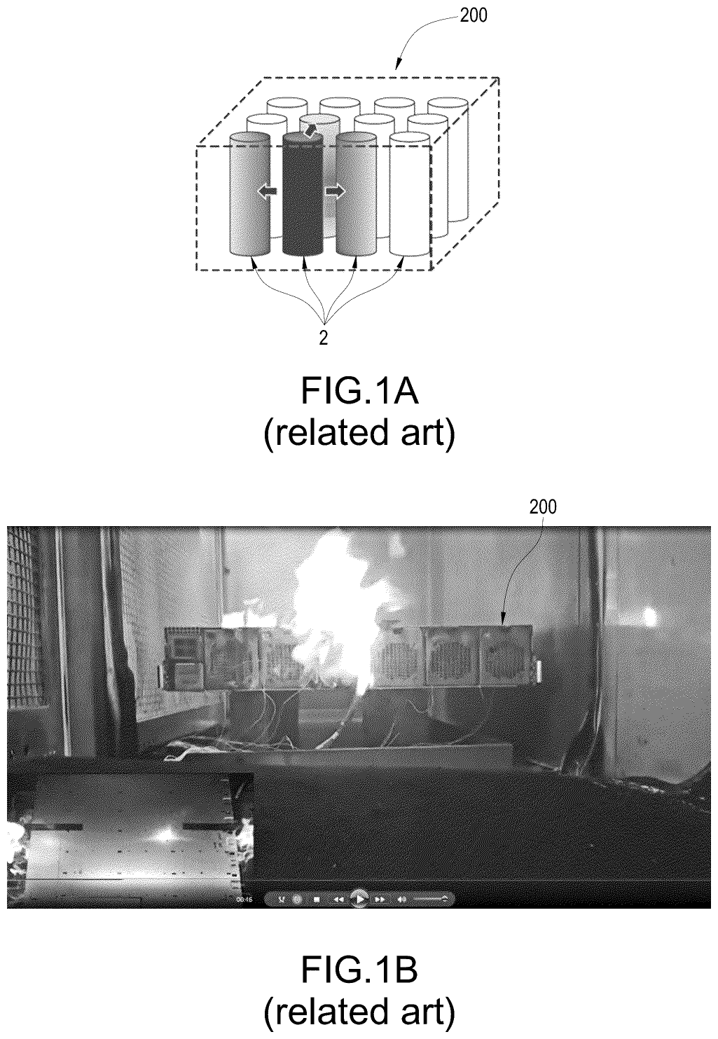

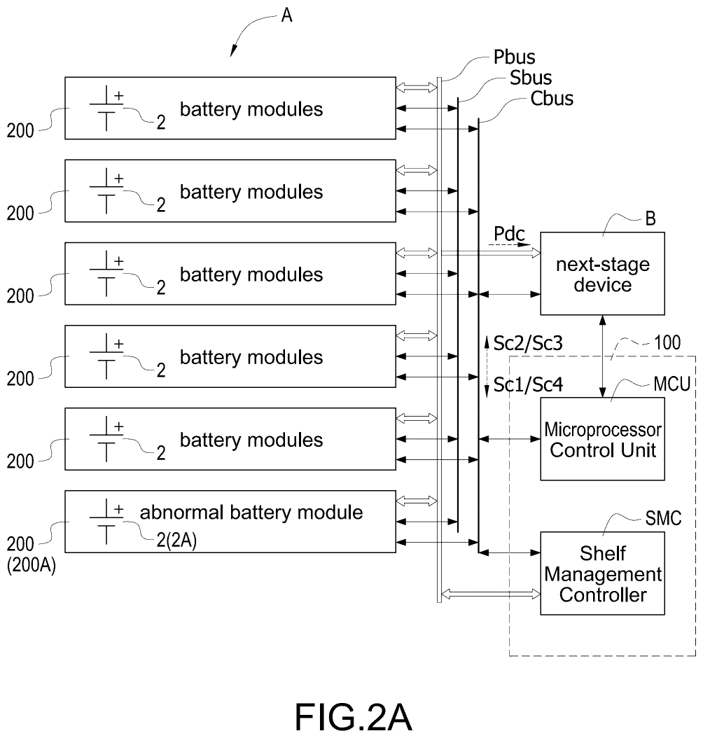

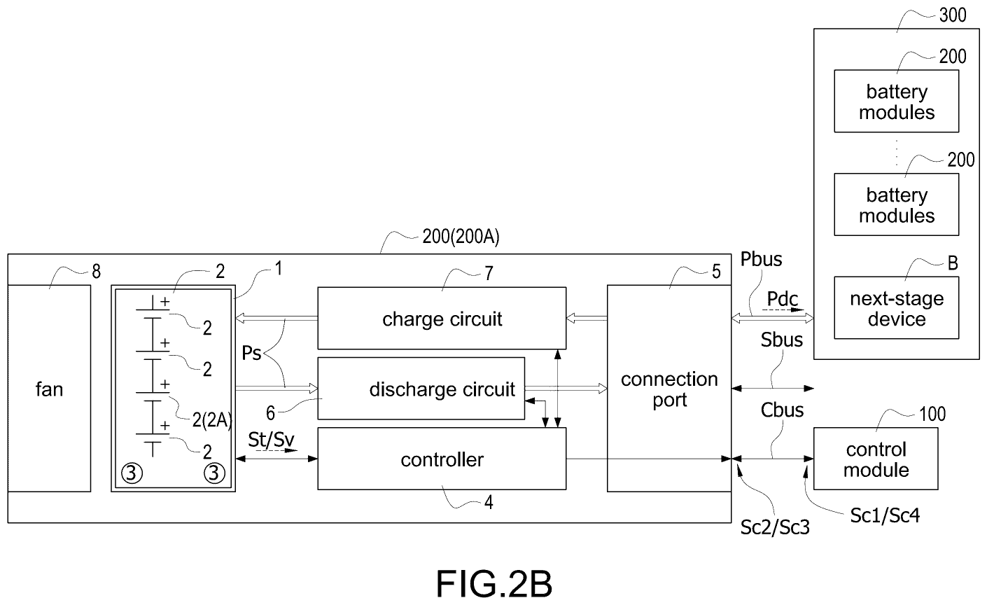

Please refer to FIG. 2A, which shows a block circuit diagram of an energy storage device capable of suppressing spread of battery fire of the present disclosure, and also refer to FIGS. 1A-1B. The energy storage device A is used to supply power to a next-stage device B, and the next-stage device B is, for example but not limited to, server(s), electric power supply system(s) and other devices requiring battery backup power supply. The energy storage device A includes a control module 100 and a plurality of battery modules 200, and the control module 100 is coupled to the next-stage device B and the battery modules 200. The battery modules 200 may be used as Backup Battery Unit (BBU). The control module 100 is used for communicating with the battery modules 200 and the next-stage device B, so as to control an operation action of the battery modules 200 accordingly (for example but not limited to, enable/disable, charging/discharging, etc.).

The control module 100 may include Shelf Management Controller (SMC) and Microprocessor Control Unit (MCU). The SMC is coupled to each battery module 200 and the MCU, and the MCU is coupled to the next-stage device B. Through the control and management of the SMC and the MCU, each battery module 200 and the next-stage device B may communicate with each other through the transmission of Flag(s) or signal(s) (hereafter referred to as control signal), so as to obtain an operation condition of each other, and control the operation action of the battery modules 200 accordingly. In one embodiment, a configure location of the control module 100 is not limited, and the type and quantity of the included (built-in) controllers are also not limited. For example, the control module 100 may be configured independently of the energy storage device A, and the SMC and the MCU may are integrated into a single control chip, or dispersed into more than three controllers for more detailed and precise detection and control.

On the other hand, the energy storage device A may further include a power bus Pbus, a sharing (Analog I-Share) bus Sbus, and a communication bus Cbus. The power bus Pbus is coupled to the control module 100, each battery module 200 and the next-stage device B, and is mainly used for power transmission. The sharing bus Sbus is coupled to each battery module 200, and is mainly used to make each battery module 200 adjust its own output current through a difference between a signal on the sharing bus Sbus and its own value of each battery module 200. In this way, the output current provided by each battery module 200 can be averaged, and it avoids the condition that the output current provided by each battery module 200 is not uniform, resulting in the condition that the battery capacity of each battery module 200 has excessive variation. The communication bus Cbus is coupled to the control module 100 (coupled to SMC) each battery module 200 and the next-stage device B, and is mainly used to transmit the control signals to enable each battery module 200 to communicate with each other.

Please refer to FIG. 2B, which shows a block circuit diagram of a battery module capable of suppressing spread of battery fire of the present disclosure, and also refer to FIGS. 1A-2A. Each battery module 200 includes an accommodation space 1, a plurality of battery packs 2, a plurality of temperature sensors 3 and a controller 4, and the accommodation space 1 may be formed by, for example but not limited to, a case. The battery packs 2 are correspondingly accommodated in the accommodation space 1, and the battery packs 2 may include a single battery or several batteries inside. The temperature sensors 3 are dispersedly arranged in the accommodation space 1 to respectively detect ambient temperatures around their configure locations. In the preferably embodiment, since the temperature sensors 3 are mainly used to detect the temperature change of the battery packs 2 during operation, the temperature sensors 3 may be attached to the surface of the battery packs 2 respectively, or configured inside the battery packs 2 respectively.

The controller 4 is coupled to the temperature sensors 3 and receives temperature signals St provided by the temperature sensors 3 to obtain the ambient temperature around each temperature sensor 3 respectively. Specifically, the controller 4 may detect various parameters of the battery module 200 (the various parameters for example but not limited to, voltage, and current), and control charging and discharging operations of the battery module 200. In addition, in one embodiment, the controller 4 may further provide a function of suppressing spread of battery fire of the battery module 200, and the controller 4 may be, for example but not limited to, microcontroller(s), programmable controller(s) and other components with signal processing functions.

In one embodiment, in order to prevent a certain battery pack(s) 2 in the battery module 200 from thermal runaway due to abnormal temperature rise as shown in FIG. 1A, the controller 4 sets a first specific temperature range. When the controller 4 determines from the temperature signal St that the ambient temperature detected by a certain temperature sensor 3 arranged in the accommodation space is greater than or equal to the first specified temperature range, it means that one or several battery packs 2 around this temperature sensor 3 may have the abnormal temperature rise (hereinafter referred to as the abnormal battery pack 2A to distinguish with the normal battery pack(s) 2), so that the ambient temperature detected by this temperature sensor 3 is greater than or equal to the first specific temperature range. Therefore, it is necessary to carry out follow-up control methods to suppress the spread of battery fire. the abnormal battery pack 2A is determined according to the location where the temperature sensor 3 is configured, and since the temperature sensor 3 detects its surrounding ambience, it means that the surrounding ambience of the temperature sensor 3 includes the abnormal working battery pack(s) (i.e. abnormal battery pack 2A), and may also include a normal working battery pack(s) (i.e. normal battery pack(s) 2). Therefore, the abnormal battery pack 2A may be defined as including at least one abnormal working battery pack 2A (of course it may also include the normal working battery pack(s) 2).

When the controller 4 determines from the temperature signal St that the ambient temperature detected by a certain temperature sensor 3 arranged in the accommodation space is greater than or equal to the first specified temperature range, the controller 4 provides a first control signal Sc1 to notify the control module 100, so as to notify the control module 100 that the battery module 200 of this controller 4 located is abnormal (hereinafter referred to as the abnormal battery module 200A to distinguish with the normal battery module(s) 200). After the control module 100 receives the first control signal Sc1, the control module 100 controls the abnormal battery module 200A to transfer itself battery capacity to the backup energy storage module 300 through the power bus Pbus, so as to suppress the spread of the battery fire through energy transfer. For the convenience of description, the above operation of transferring the battery capacity of the abnormal battery module 200A to the backup energy storage module 300 may be referred to as an energy transfer mode. Among them, the backup energy storage module 300 may include devices such as the normal battery module(s) 200 other than the abnormal battery module 200A, or the next-stage device B. The main purpose is to transfer out the battery capacity of the abnormal battery module 200A as soon as possible.

During the period when the battery capacity of the abnormal battery module 200A is transferred out, the controller 4 continuously detects various parameters (for example but not limited to, voltage, current, temperature and/or time) of the battery module 100 through various sensor(s), detection circuit(s) and/or timer(s), and notify the control module 100 through the communication bus Cbus. For example, the battery module 200 may include a plurality of voltage sensors (not shown in FIG.), the voltage sensors are respectively coupled to the battery packs 2 and the controller 4, and respectively detect battery voltages (for example but not limited to, 4.2V) of the battery packs 2 to respectively provide the voltage signals Sv to the controller 2, so that the controller 4 may obtain the battery voltage value of each battery pack 2 through the voltage signals Sv.

Further, refer to FIGS. 2A-2B, each battery module 200 further includes a connection port 5, a discharge circuit 6 and a charge circuit 7. The connection port 5 is coupled to the next-stage device B and the connection port 5 of the other battery modules 200 through the power bus Pbus, and the discharge circuit 6 and the charge circuit 7 are respectively coupled to the battery packs 2 and the connection port 5. The discharge circuit 6 is used to convert an energy storage power Ps provided by the battery packs 2 into a DC power Pdc, so as to provide the DC power Pdc to the power bus Pbus through the connection port 5. The charge circuit 7 is used to convert the DC power Pdc on the power bus Pbus into the energy storage power Ps to charge the battery packs 2. When the battery module 200 is operating normally, the discharge circuit 6 and the charge circuit 7 are mainly used to adjust the battery capacity of the battery packs 2. Therefore, the next-stage device B and the battery module 200 can obtain/provide power from the power bus Pbus according to actual requirements. The power bus Pbus may be coupled to an external power device (not shown in the FIG.) to provide the DC power Pdc to charge the battery module 200, so as to prevent the battery module 200 from running out of battery capacity due to long-term operation. Alternatively, the battery module 200 may also use a replacement method to replace the battery module 200 having exhausted battery capacity with a battery module 200 having full battery capacity. In addition, in one embodiment, the definition of “power” may include at least one of voltage, current and/or power source.

On the other hand, when the battery module 200 is abnormal (namely, the battery module 200 is abnormal battery module 200A), the control module 100 will provide a second control signal Sc2 to the controller 4 of the abnormal battery module 200A based on the first control signal Sc1. The controller 4 of the abnormal battery module 200A controls the discharge circuit 6 of the abnormal battery module 200A to convert the energy storage power Ps of the battery packs 2 (includes abnormal battery pack 2A) into the DC power Pdc based on the second control signal Sc2, so as to transfer the battery capacity of the abnormal battery module 200A to the backup energy storage module 300.

Under the above conditions, the control module 100 may include at least two subsequent operation methods. The first operation method is to control the remaining battery modules 200 that are operating normally to receive the battery capacity transferred from the abnormal battery module 200A. Specifically, the first operation mode is that, when the control module 100 provides the second control signal Sc2 to the controller 4 of the abnormal battery module 200A based on the first control signal Sc1, the control module 100 also provides a third control signal Sc3 to the controller 4 of each battery modules 200 in normal operation based on the first control signal Sc1. After the controller 4 of each normally operating battery module 200 receives the third control signals Sc3, the controller 4 controls the charge circuit 7 of its own battery module 200 to convert the DC power Pdc into the energy storage power Ps based on the third control signal Sc3. In this way, the battery capacity of the abnormal battery module 200A may be transferred to the normal battery modules 200 by transferring the battery capacity of the abnormal battery module 200A out and transferring the battery capacity of the normal battery module 200 in.

The second operation method is that the controller 4 of the abnormal battery module 200A controls its own discharge circuit 6 to provide the DC power Pdc to the next-stage device B based on the second control signal Sc2. In this way, the battery capacity of the abnormal battery module 200A can be transferred to supply the power required for the operation of the next-stage device B with higher priority. The above two operation modes can be selected or coexist, which means that the battery capacity of the abnormal battery module 200A can be transferred out to the normal battery modules 200 and the next-stage device B at the same time, or one of them will be transferred in with battery capacity. When choosing to transfer its battery capacity to the normal battery modules 200, the next-stage device B may choose to temporarily shut down or temporarily disconnect the power bus Pbus.

On the other hand, the battery module 200 may transfer the battery capacity through at least two control methods. One of them is that the controller 4 of the abnormal battery module 200A increases the output voltage of the DC power Pdc output by the discharge circuit 6 (for example but not limited to, from conventional 48V to 51V) so that the abnormal battery module 200A may discharge more battery capacity. Another one is that the controller 4 of the battery modules 200 controls the transfer of the battery capacity by respectively controlling discharge circuit 6 and the charge circuit 7 to be enabled or disabled. More particularly, the above two control methods may be used in combination, and in one embodiment, the methods for realizing the transfer of battery capacity are not limited to the above two methods, and any method that can realize the transfer of battery capacity should be included in the scope of this embodiment.

Taking the above two control methods as an example, the abnormal battery module 200A may increase the output voltage of the DC power Pdc output by the discharge circuit 6, and may enable the charge circuit 7 and disable the discharge circuit 6 of the normal battery modules 200 at the same time. In this way, the battery capacity of the abnormal battery module 200A may be provided to the normal battery modules 200 and the next-stage device B at the same time. Alternatively, the abnormal battery module 200A may not increase the output voltage, and disable the discharge circuit 6 and the charge circuit 7 of the normal battery module 200 at the same time. In this way, the power supply of the next-stage device B may be completely provided by the abnormal battery module 200A, provided that the output current (maximum) supplied by the abnormal battery module 200A meets the requirement of the next-stage device B. Subsequently, when the abnormal battery module 200A cannot supply enough output current, the control module 100 notifies the normal battery modules 200 one by one to activate the discharge circuit 6. Therefore, under the logic of the above control methods, those skilled in the art may deduce multiple control methods, and they will not be repeated here for brevity.

Please refer to FIGS. 2A to 2B, after entering the energy transfer mode, according to an example, two operation methods for exiting the energy transfer mode may be performed. The first operation method is that the control module 100 still continuously controls the abnormal battery module 200A to be in the energy transfer mode, so that the battery capacity of the abnormal battery module 200A is discharged to a low power level (for example but not limited to, 5%) or an empty power level. The second operation method is that when the controller 4 determines that the parameters corresponding to the abnormal battery module 200A satisfy certain conditions, it means that the battery capacity of the abnormal battery module 200A is consumed to a safe amount. Therefore, the controller 4 provides the fourth control signal Sc4 to notify the control module 100, and the control module 100 controls the energy storage device to exit the energy transfer mode based on the fourth control signal Sc4, so as to stop transferring the battery capacity of the abnormal battery module 200A to the backup energy storage module 300. Furthermore, it takes time for the internal battery cell in the first battery pack 2 with abnormality to increase its temperature from abnormal temperature to thermal runaway. Therefore, the battery capacity of this abnormal battery pack 2 in the abnormal battery module 200A with abnormality is quickly consumed through the energy transfer mode, thereby suppressing the impact caused by the spread of the battery fire, also ensuring that the fire will not completely spread after the thermal runaway of the battery cell, and it improves the safety of the battery system.

The first specific temperature range may be a range value formed with temperature values such as a first temperature difference threshold and a first temperature threshold. Under the condition that the first specific temperature range is the first temperature difference threshold, and when the controller 4 obtains from the temperature signal St that a temperature difference (for example but not limited to, 22 degrees) of the ambient temperature (for example but not limited to, 62 degrees) detected by the temperature sensor 3 of the abnormal battery pack 2A and the ambient temperature (for example but not limited to 40 degrees, generally the lowest value being taken) detected by the one of remaining of the temperature sensor 3 (i.e. normal working battery pack(s) 1) is greater than or equal to the first temperature difference threshold (for example but not limited to, 20 degrees), it means that the controller 4 determines that the ambient temperature is greater than or equal to the first specific temperature range. At this time, the controller 4 may provide the first control signal Sc1 to notify the control module 100, so that the control module 100 will transfer the battery capacity of the abnormal battery module 200A to the backup energy storage module 300, so as to suppress the impact caused by the spread of the battery fire.

Under the condition that the first specific temperature range is the first temperature threshold, and when the controller 4 obtains from the temperature signal St that the ambient temperature (for example but not limited to, 92 degrees) detected by the temperature sensor 3 of the abnormal battery pack 2A is greater than or equal to the first temperature threshold (for example but not limited to, 90 degrees), it means that the controller 4 determines that the ambient temperature is greater than or equal to the first specific temperature range. At this time, the controller 4 may provide the first control signal Sc1 to notify the control module 100, so that the control module 100 will transfer the battery capacity of the abnormal battery module 200A to the backup energy storage module 300, so as to suppress the impact caused by the spread of the battery fire.

On the other hand, since the energy storage device A may further include the sharing bus Sbus for making each battery module 200 average (uniform) its own output current, after entering the energy transfer mode, the abnormal battery module 200A performs energy transfer out, and the normal battery modules 200 may perform energy transfer in, transfer out or disable. Therefore, after entering the energy transfer mode, the output current of the normal battery modules 200 and the abnormal battery module 200A should be different, and the sharing bus Sbus may no longer be used to average the output current of each battery modules 200. Therefore, after the control module 100 receives the first control signal Sc1, the control module 100 controls the connection port 5 of the abnormal battery module 200A to be disconnected from the sharing bus Sbus, so as not to average the output current with the other battery modules 200 (i.e. normal battery modules 200). The other battery modules 200 (i.e. normal battery modules 200) may selectively control whether the connection port 5 is still coupled to the sharing bus Sbus according to the steps of energy transfer in, transfer out or disable, so as to provide the function of averaging the output current continuously.

Please refer to FIG. 2B, each battery module 200 may further include a fan 8, and the fans 8 is coupled to the controller 4. The fan 8 is used to dissipate heat from the battery packs 2 so as to prevent the temperature of the battery packs 2 from being too high to trigger a protection function, and when the temperature of the battery packs 2 cannot be effectively cooled after the fan 8 dissipates heat, the energy transfer mode is entered (i.e. when the controller 4 determines that the ambient temperature detected by the certain temperature sensor 3 arranged in the accommodation space is greater than or equal to the first specified temperature range).

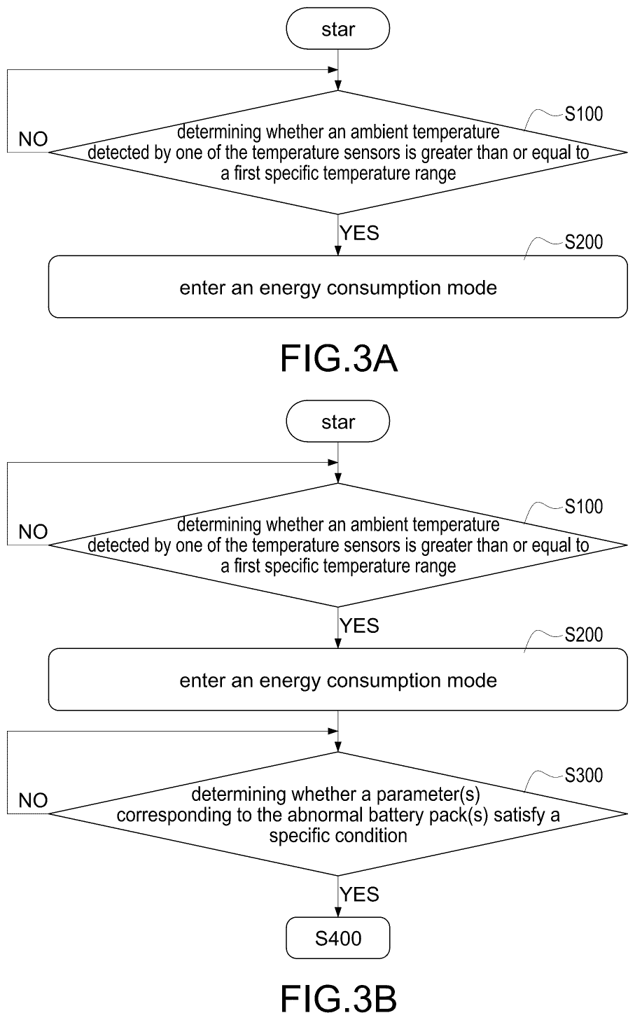

Please refer to FIG. 3A, which shows a flowchart of a control method of the battery module according to a first embodiment of the present disclosure, and also refer to FIGS. 2A-2B. The method shown in FIG. 3A is mainly to prevent the certain battery pack(s) 2 in the battery module 200 from thermal runaway due to abnormal temperature rise as shown in FIG. 1A, and to suppress the impact caused by the spread of the battery fire. Therefore, the control method of suppressing spread of battery fire determines whether an ambient temperature detected by one of the temperature sensors is greater than or equal to a first specific temperature range (S100). In one embodiment, the first specific temperature range may be set by the controller 4, and the controller 4 determines whether the ambient temperatures detected by the temperature sensors 3 arranged in the accommodation space 1 is greater than or equal to the first specific temperature range through the temperature signals St.

Then, when the controller 4 determines from the temperature signal St that the ambient temperature detected by the certain temperature sensor 3 arranged in the accommodation space 1 is greater than or equal to the first specific temperature range, it means that one or several battery packs 2 around this temperature sensor 3 may have the abnormal temperature rise, so that the controller 4 provides the first control signal Sc1 to notify the control module 100 to enter the energy transfer mode (S200). Otherwise, the method returns to the step (S100).

In the step (S200), the control module 100 continuously transfers the battery capacity of the abnormal battery module 200A providing the first control signal Sc1 to the backup energy storage module 300, so that the battery capacity of the abnormal battery module 200A is discharged to a low power level (for example but not limited to, 5%) or an empty power level. After the battery capacity of the abnormal battery module 200A is discharged to the low power level or the empty power level, the steps of FIG. 3A is ended, and in these steps, the control module 100 will not stop consuming the battery capacity of the abnormal battery module 200A because the battery capacity of the abnormal battery module 200A is discharged to the low power level or the empty power level. The backup energy storage module 300 may include devices such as the normal battery module(s) 200 other than the abnormal battery module 200A, or the next-stage device B. The main purpose is to transfer out the battery capacity of the abnormal battery module 200A as soon as possible.

Please refer to FIG. 3B, which shows a flowchart of the control method of the battery module according to a second embodiment of the present disclosure, and also refer to FIGS. 2A-3A. The difference between FIG. 3B and FIG. 3A is that after the step (S200), it further determines whether a parameter(s) corresponding to the abnormal battery module 200A satisfies a specific condition (S300). In one embodiment, the step (S300) continuously detects various parameters (for example but not limited to, voltage, current, temperature and/or time) of the abnormal battery module 200A through various sensor(s), detection circuit(s) and/or timer(s). When the step (S300) is determined to be yes, the method stops transferring the battery capacity of the abnormal battery module to the backup energy storage module and enter step (S400) to exit the energy transfer mode. Otherwise, it returns to the step (S300) for continual detection and determination. In one embodiment, the process steps not described in FIG. 3B are the same as those in FIG. 3A, and the description thereof will not be repeated here for brevity.

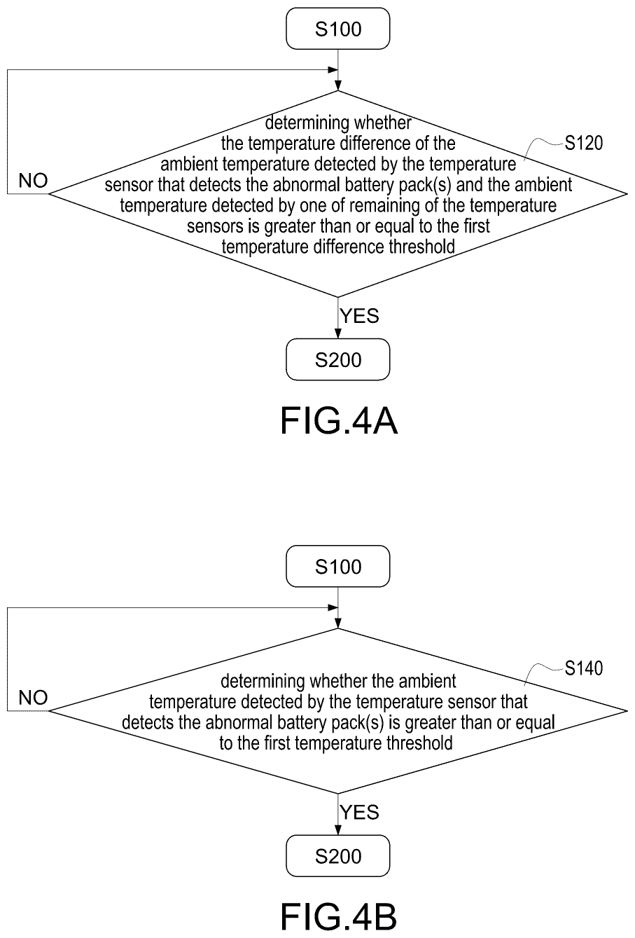

Please refer to FIG. 4A, which shows a flowchart of the control method for entering the energy transfer mode according to a first embodiment of the present disclosure, and also refer to FIGS. 2A-3B. The controller 4 may pre-set the first specific temperature range as the first temperature difference threshold (for example but not limited to, 20 degrees), and the step (S100) further determines whether the temperature difference of the ambient temperature detected by the temperature sensor for detecting the abnormal battery pack and the ambient temperature detected by one of remaining of the temperature sensors is greater than or equal to the first temperature difference threshold (S120). If yes, it means that the temperature difference is greater than or equal to 20 degrees, and the method enters the energy transfer mode (S200). Otherwise, it returns to the step (S120) for continual determination.

Please refer to FIG. 4B, which shows a flowchart of the control method for entering the energy transfer mode according to a second embodiment of the present disclosure, and also refer to FIGS. 2A-4A. The controller 4 may pre-set the first specific temperature range as the first temperature threshold (for example but not limited to, 90 degrees), and the step (S100) further determines whether the ambient temperature detected by the temperature sensor for detecting the abnormal battery pack is greater than or equal to the first temperature threshold (S140). If yes, it means that the ambient temperature is greater than or equal to 90 degrees, and the method enters the energy consumption mode (S200). Otherwise, it returns to the step (S140) for continuous determination.

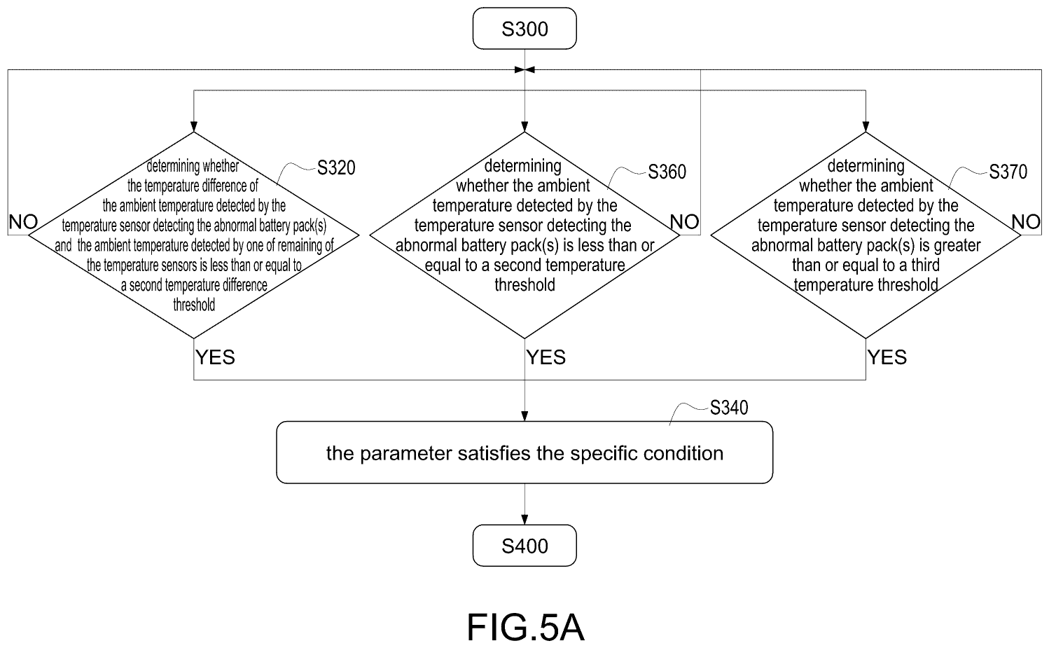

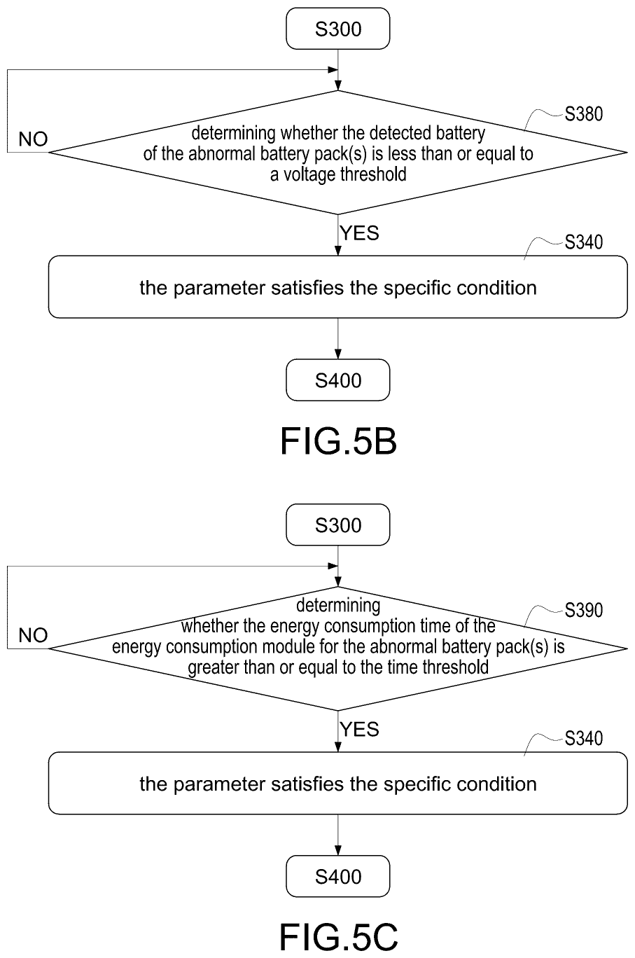

Please refer to FIG. 5A, which shows a flowchart of the control method for exiting the energy transfer mode according to a first embodiment of the present disclosure, and also refer to FIGS. 2A-4B. FIG. 5A is applicable to the process steps of FIG. 3B, the parameter is set as ambient temperature, and the specific condition is set as the second specific temperature range. The step (S300) further determines, when the second specific temperature range is the second temperature difference threshold, whether the temperature difference of the ambient temperature detected by the temperature sensor detecting the abnormal battery pack and the ambient temperature detected by one of remaining of the temperature sensors is less than or equal to a second temperature difference threshold. When the temperature difference is less than or equal to the second temperature difference threshold (for example but not limited to, the difference is less than 20 degrees), it means that the parameter satisfies the specific condition (S340) and enters step (S400). Otherwise, it returns to the step (S320) for continual determination.

On the other hand, the step (S300) may further determine, when the second specific temperature range is the second temperature threshold, whether the ambient temperature detected by the temperature sensor for detecting the abnormal battery pack is less than or equal to a second temperature threshold (S360). When the ambient temperature is less than or equal to the second temperature threshold (for example but not limited to, the detected ambient temperature is less than 90 degrees), it means that the parameter satisfies the specific condition (S340) and enters the step (S400). Otherwise, it returns to the step (S360) for continual determination. Generally, what happens in the step (S360) is that when the energy storage device A is actually running, after the ambient temperature of the abnormal battery module 200A exceeds 90 degrees, the ambient temperature of the abnormal battery module 200A is lowered to be less than 90 degrees again due to the transfer of battery capacity and the heat dissipating of the fan 8, but it does not rule out other situations where the step (S360) may occur.

On the other hand, the step (S300) may also determine, when the second specific temperature range is the third temperature threshold, whether the ambient temperature detected by the temperature sensor for detecting the abnormal battery pack is greater than or equal to a third temperature threshold (S370). when the ambient temperature is greater than or equal to the third temperature threshold (for example but not limited to, the detected ambient temperature is above 150 degrees), it means that the parameter satisfies the specific condition (S340) and the method enters the step (S400). Otherwise, it returns to the step (S370) for continual determination. Generally, what happens in the step (S370) is that when the energy storage device A is performing the fire spread test, a set of battery modules 200 is deliberately selected to be heated to over 150 degrees (usually heated to 220 degrees), and the situation of energy storage device A burning is observed. After the ambient temperature exceeds 150 degrees, the abnormal battery module 200A may start to burn, so it is necessary to disable some (or all) of the controllable modules inside the abnormal battery module 200A before heating to more than 150 degrees, and the controllable modules that need to be disabled may be set. In particular, the fan 8 must be turned off to prevent the outside air introduced by the fan 8 from aggravating the spread of the battery fire after the abnormal battery module 200A starts to burn. Steps (S320), (360) and (S370) may be performed selectively, and it is not excluded that they may be integrated into one for common determination.

Please refer to FIG. 5B, which shows a flowchart of the control method for exiting the energy transfer mode according to a second embodiment of the present disclosure, and also refer to FIGS. 2A-5A. FIG. 5B is also applicable to the process steps of FIG. 3B, the parameter is set to the battery voltages, and the specific condition is set to the voltage threshold. The step (S300) further determines whether the detected battery voltage(s) of the abnormal battery pack is less than or equal to a voltage threshold (S380), (that is, the number of battery voltage(s) corresponds to the number of abnormal battery pack 2A). When the battery voltage(s) is less than or equal to the voltage threshold (for example but not limited to the battery voltage(s) is lower than the voltage threshold of 3.8V), it means that the parameter satisfies the specific condition (S340) and the method enters the step (S400). Otherwise, it returns to the step (S380) for continual determination.

Please refer to FIG. 5C, which shows a flowchart of the control method for exiting the energy transfer mode according to a third embodiment of the present disclosure, and also refer to FIGS. 2A-5B. FIG. 5C is also applicable to the process steps of FIG. 3B, the parameter is set to be the transfer time, and the specific condition is set to the time threshold. The step (S300) further includes that determining whether the transfer time of the battery capacity of the abnormal battery module being greater than or equal to the time threshold (S390). When the transfer time is greater than or equal to the time threshold (for example but not limited to, the transfer time of the battery capacity of the abnormal battery module 200A is higher than the time threshold of 10 minutes), it means that the parameter satisfies the specific condition (S340) and the method enters the step (S400). Otherwise, it returns to the step (S390) for continual determination. In one embodiment, the process steps not described in FIGS. 3A-5C are the same as those in FIGS. 2A-2B, and the description thereof will not be repeated here for brevity.

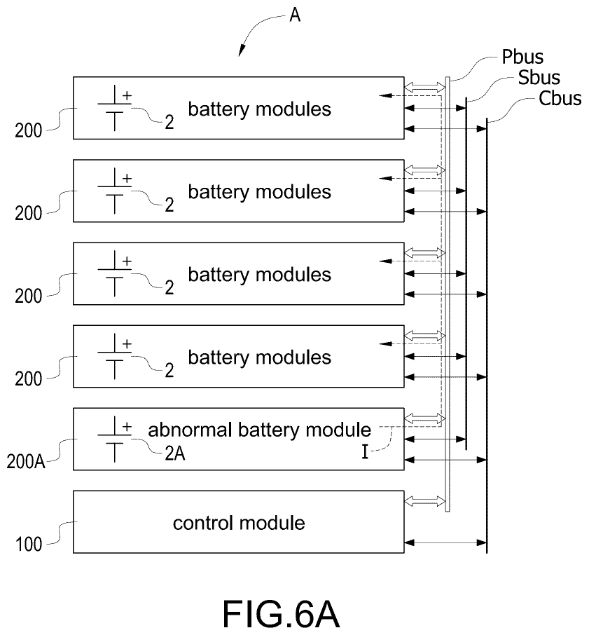

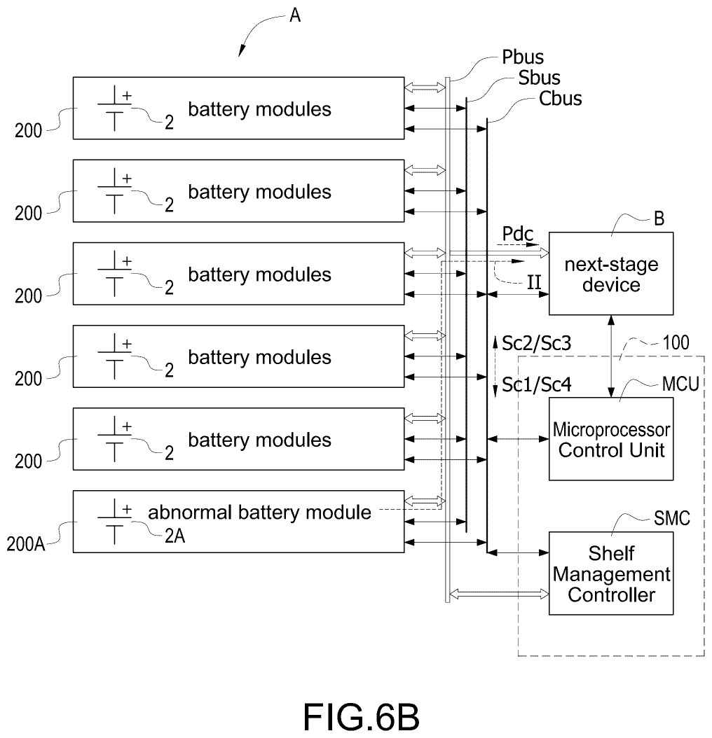

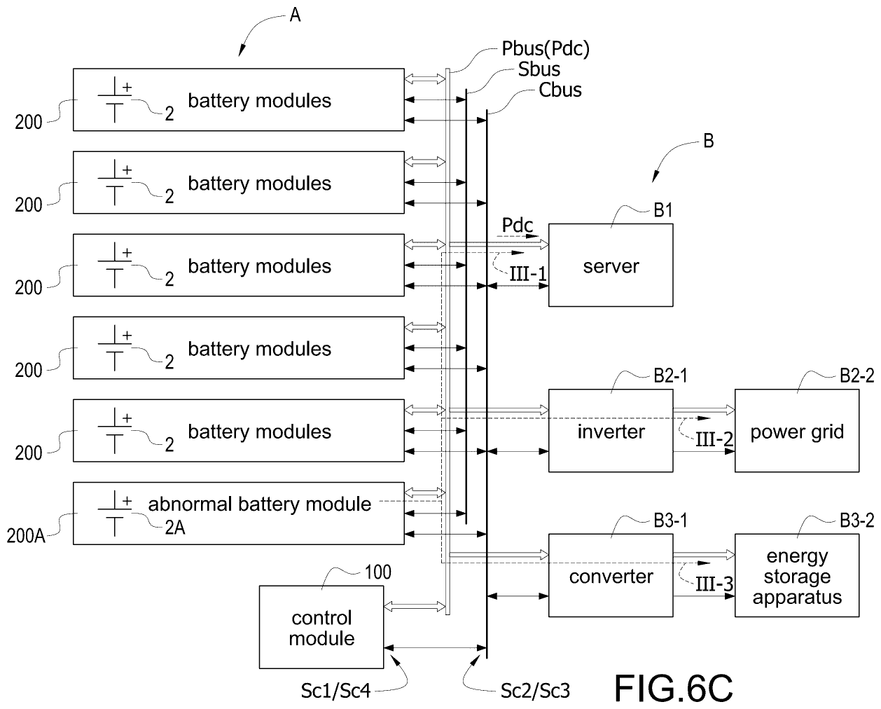

Please refer to FIG. 6A, which shows a transfer path diagram of the energy transfer mode according to a first embodiment of the present disclosure, and also refer to FIGS. 2A-5C. In the embodiment of FIG. 6A, the features of FIGS. 2A to 5C are selectively taken out for a schematic example. When the controller 4 determines from the temperature signal St that the ambient temperature detected by the certain temperature sensor 3 arranged in the accommodation space is greater than or equal to the first specified temperature range, the controller 4 provides the first control signal Sc1 to notify the control module 100 to enter the energy transfer mode. In one embodiment, the next-stage device B is temporarily disabled, and the charge circuit 7 of each normal battery modules 200 is enabled. In the energy transfer mode, the transfer method set by the control module 100 is that the battery capacity of the abnormal battery module 200A is forced to transfer out, the remaining battery modules 200 that are operating normally perform energy transfer in, and the control module 100 may even adjust the charging voltage and protection point of the charge circuit 7 of the battery modules 200 that are operating normally. Then, the control module 100 controls the abnormal battery module 200A to increase the output voltage, so as to transfer the battery capacity of the abnormal battery module 200A to the normal battery modules 200 (as shown in path I). When the battery voltage of the battery packs 2 of the abnormal battery module 200A drops to a safe voltage range, the controller 4 notifies the control module 100 to stop the energy transfer through a control signal. For example, the battery voltage of each battery drops below 3.7V, which can correspond to the battery capacity of the abnormal battery module 200A dropping below 60%.

Please refer to FIG. 6B, which shows a transfer path diagram of the energy transfer mode according to a second embodiment of the present disclosure, and also refer to FIGS. 2A-5C. In the embodiment of FIG. 6B, the features of FIGS. 2A to 5C are also selectively taken out for a schematic example, and the difference between FIG. 6B and FIG. 6A is that the next-stage device B in FIG. 6B is in the operating state, and the discharge circuit 6 and the charge circuit 7 of the normal battery modules 200 are both disabled. In the energy transfer mode, the control module 100 sets the transfer mode as the abnormal battery module 200A is forced to transfer out, and the next-stage device B is operating continually. Since the discharge circuit 6 and the charge circuit 7 of the normal battery module 200 are disabled, the abnormal battery module 200A may preferentially discharge the next-stage device B, the next-stage device B may preferentially consume the battery capacity of the abnormal battery module 200A (as shown in path II). When the battery voltage of the battery packs 2 of the abnormal battery module 200A drops to the safe voltage range, the controller 4 notifies the control module 100 to stop the energy transfer through a control signal. (For example, the battery voltage of each battery drops below 3.7V, which can correspond to the battery capacity of the abnormal battery module 200A dropping below 60%).

Please refer to FIG. 6C, which shows a transfer path diagram of the energy transfer mode according to a third embodiment of the present disclosure, and also refer to FIGS. 2A-5C. In the embodiment of FIG. 6C, the features of FIGS. 2A to 5C are also selectively taken out for a schematic example, and the difference between FIG. 6C and FIG. 6B is that the next-stage device B in FIG. 6C includes devices such as a server B1, an inverter B2-1, a power grid B2-2, a converter B3-1, and an energy storage apparatus B3-2. The abnormal battery module 200A may preferentially supply power to the server B1 (as shown in path III-1), and the inverter B2-1 may also convert the battery capacity of the abnormal battery module 200A to feed power to the power grid B2-2 (as shown in path III-2). In addition, the converter B3-1 may also convert the battery capacity of the abnormal battery module 200A to store power in the energy storage apparatus B3-2 (as shown in path III-3), and the energy storage apparatus B3-2 for example but not limited to, Energy Storage System (ESS). Although FIG. 6C shows a unidirectional power supply path from the abnormal battery module 200A to the next-stage device B, if the inverter B2-1 and the converter B3-1 have a bidirectional conversion function, the power of the power grid B2-2 and the energy storage apparatus B3-2 may also be fed to the power bus Pbus through the bidirectional conversion function.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An energy storage device for suppressing spread of battery fire coupled to a next-stage device, the energy storage device comprising:
a control module coupled to the next-stage device, and
a plurality of battery modules respectively coupled to the control module and the next-stage device, the control module configured to control the battery modules to supply power to the next-stage device, the battery modules respectively comprising:
an accommodation space,
a plurality of battery packs arranged in the accommodation space,
a plurality of temperature sensors dispersedly arranged in the accommodation space, and the temperature sensors configured to respectively detect an ambient temperature around the temperature sensors, and
a controller coupled to the temperature sensors, and the controller configured to provide a first control signal to notify the control module when the ambient temperature detected by one of the temperature sensors is greater than or equal to a first specific temperature range,
wherein the control module is configured to transfer a battery capacity of a battery module providing the first control signal to a backup energy storage module, and the backup energy storage module comprises at least one battery module other than the battery module sending the first control signal, or the next-stage device.

2. The energy storage device as claimed in claim 1, wherein the battery modules further respectively comprise:
a connection port coupled to the next-stage device and connection ports of remaining of the battery modules through a power bus,
a discharge circuit coupled to the battery packs and the connection port, and configured to convert an energy storage power provided by the battery packs into a DC power supply, so as to provide the DC power to the power bus through the connection port, and
a charge circuit coupled to the battery packs and the connection port, and configured to convert the DC power into the energy storage power to charge the battery packs,
wherein the control module is configured to provide a second control signal to the controller of the battery module based on the first control signal, and the controller of the battery module is configured to control the discharge circuit of the battery module to convert the energy storage power into the DC power based on the second control signal, so as to transfer the battery capacity of the battery module to the backup energy storage module.

3. The energy storage device as claimed in claim 2, wherein the control module is configured to provide a third control signal to the controller of the at least one battery module based on the first control signal, and the controller of the at least one battery module is configured to control the charge circuit of the at least one battery module to convert the DC power into the energy storage power based on the third control signal, so as to transfer the battery capacity of the battery module to the at least one battery module.

4. The energy storage device as claimed in claim 2, wherein the controller of the battery module is configured to control the discharge circuit of the battery module to provide the DC power to the next-stage device based on the second control signal, so as to transfer the battery capacity of the battery module to the next-stage device.

5. The energy storage device as claimed in claim 2, wherein the controller is configured to transfer the battery capacity by increasing an output voltage of the DC power output by the discharge circuit.

6. The energy storage device as claimed in claim 2, wherein the controller is configured to transfer the battery capacity by respectively controlling the discharge circuit and the charge circuit to be enabled or disabled.

7. The energy storage device as claimed in claim 1, wherein the first specific temperature range is a first temperature difference threshold, the controller is configured to provide the first control signal based on a temperature difference between the ambient temperature detected by the one of the temperature sensors and an ambient temperature detected by one of remaining of the temperature sensors being greater than or equal to the first temperature difference threshold, or
wherein the first specific temperature range is a first temperature threshold, and the controller is configured to provide the first control signal when the ambient temperature detected by the one of the temperature sensors is greater than or equal to the first temperature threshold.

8. The energy storage device as claimed in claim 1, wherein the controller is configured to provide a fourth control signal to notify the control module when the controller determines that a parameter corresponding to the battery module satisfies a specific condition, and the control module is configured to stop transferring the battery capacity of the battery module to the backup energy storage module based on the fourth control signal.

9. The energy storage device as claimed in claim 8, wherein the parameter is the ambient temperature, and the specific condition is a second specific temperature range,
wherein the second specific temperature range is a second temperature difference threshold, the controller is configured to determine that the parameter satisfies the specific condition based on a temperature difference between the ambient temperature detected by the one of the temperature sensors and an ambient temperature detected by one of remaining of the temperature sensors being less than or equal to the second temperature difference threshold,
wherein the second specific temperature range is a second temperature threshold, and the controller is configured to determine that the parameter satisfies the specific condition based on the ambient temperature detected by the one of the temperature sensors being less than or equal to the second temperature threshold, or
wherein the second specific temperature range is a third temperature threshold, and the controller is configured to determine that the parameter satisfies the specific condition based on the ambient temperature detected by the one of the temperature sensors being greater than or equal to the third temperature threshold.

10. The energy storage device as claimed in claim 8, the battery modules further respectively comprise:
a plurality of voltage sensors respectively coupled to the battery packs and the controller, configured to respectively detect battery voltages of the battery packs,
wherein the parameter is the battery voltages, and the specific condition is a voltage threshold, the controller is configured to determine that the parameter satisfies the specific condition based on the battery voltages of the battery packs being less than or equal to the voltage threshold.

11. The energy storage device as claimed in claim 8, wherein the parameter is a transfer time, and the specific condition is a time threshold, the controller is configured to determine that the parameter satisfies the specific condition based on the transfer time of the battery capacity of the battery module being transferred is greater than or equal to the time threshold.

12. A control method of suppressing spread of battery fire, applied to an energy storage device, and the energy storage device comprising a plurality of battery modules; the battery modules respectively comprising a plurality of battery packs arranged in an accommodation space, a plurality of temperature sensors dispersedly arranged in the accommodation space, and the control method comprising:
determining whether an ambient temperature detected by one of the temperature sensors being greater than or equal to a first specific temperature range, and
providing a first control signal to enter an energy transfer mode when the ambient temperature detected by the one of the temperature sensors is greater than or equal to the first specific temperature range, and the energy transfer mode comprising a step of:
transferring a battery capacity of a battery module that provides the first control signal to a backup energy storage module,
wherein the backup energy storage module comprises at least one battery module other than the battery module, or the next-stage device.

13. The control method of suppressing spread of battery fire as claimed in claim 12,
wherein the first specific temperature range is a first temperature difference threshold, and the control method further comprising:
determining whether a temperature difference between the ambient temperature detected by the temperature sensor and an ambient temperature detected by one of remaining of the temperature sensors is greater than or equal to the first temperature difference threshold, and
entering the energy transfer mode when the temperature difference is greater than or equal to the first temperature difference threshold.

14. The control method of suppressing spread of battery fire as claimed in claim 12, wherein the first specific temperature range is a first temperature threshold, and the control method further comprising:
determining whether the ambient temperature detected by the temperature sensor is greater than or equal to the first temperature threshold, and
entering the energy transfer mode when the ambient temperature is greater than or equal to the first temperature threshold.

15. The control method of suppressing spread of battery fire as claimed in claim 12, wherein the battery modules further comprise a discharge circuit and a charge circuit respectively, and the control method of suppressing spread of battery fire further comprises steps of:
converting an energy storage power provided by the battery packs into a DC power supply, so as to provide the DC power to the next-stage device through a power bus, and
converting the DC power into the energy storage power to charge the battery packs,
wherein the energy transfer mode comprises steps of:
(a1) controlling the discharge circuit of the battery module to convert the energy storage power into the DC power supply, so as to transfer the battery capacity of the battery module to the backup energy storage module,
(a2) controlling the charge circuit of the at least one battery module to convert the DC power into the energy storage power, so as to transfer the battery capacity of the battery module to the at least one battery module; or
(a3) controlling the discharge circuit of the battery module to provide the DC power to the next-stage device, so as to transfer the battery capacity of the battery module to the next-stage device.

16. The control method of suppressing spread of battery fire as claimed in claim 15, wherein steps (a1) to (a3) further comprise steps of:
(a) transferring the battery capacity by increasing an output voltage of the DC power output by the discharge circuit; or
(a″) transferring the battery capacity by respectively controlling the discharge circuit and the charge circuit to be enabled or disabled.

17. The control method of suppressing spread of battery fire as claimed in claim 12, wherein the energy transfer mode further comprises steps of:
(b) determining whether a parameter corresponding to the battery module satisfies a specific condition, and
(c) stop transferring the battery capacity of the battery module to the backup energy storage module to exit the energy transfer mode when the parameter satisfies the specific condition.

18. The control method of suppressing spread of battery fire as claimed in claim 17,
wherein the parameter is set to be the ambient temperature, the specific condition is set to be a second specific temperature range, and the energy transfer mode further comprises steps of:
(b1-1) determining whether the temperature difference between the ambient temperature detected by the one of the temperature sensors and an ambient temperature detected by one of remaining of the temperature sensors is less than or equal to a second temperature difference threshold when the second specific temperature range is the second temperature difference threshold, and
(b1-2) determining the parameter satisfies the specific condition when the temperature difference is less than or equal to the second temperature difference threshold, or
(b2-1) determining whether the ambient temperature detected by the one of the temperature sensors is less than or equal to a second temperature threshold when the second specific temperature range is the second temperature threshold, and
(b2-2) determining the parameter satisfies the specific condition when the ambient temperature is less than or equal to the second temperature threshold, or
(b3-1) determining whether the ambient temperature detected by the one of the temperature sensors is greater than or equal to a third temperature threshold when the second specific temperature range is the third temperature threshold, and
(b3-2) determining the parameter satisfies the specific condition when the ambient temperature is greater than or equal to the third temperature threshold.

19. The control method of suppressing spread of battery fire as claimed in claim 17, wherein the parameter is set to be battery voltages, and the specific condition is set to be a voltage threshold, and the energy transfer mode further comprises steps of:
(b4-1) determining whether the battery voltages of the battery packs are less than or equal to the voltage threshold, and
(b4-2) determining the parameter satisfies the specific condition when the battery voltages are less than or equal to the voltage threshold.

20. The control method of suppressing spread of battery fire as claimed in claim 17, wherein the parameter is set to be a transfer time, and the specific condition is set to be a time threshold, and the energy transfer mode further comprises steps of:
(b5-1) determining whether the transfer time of the battery capacity of the battery module is greater than or equal to the time threshold, and
(b5-2) determining the parameter satisfies the specific condition when the transfer time is greater than or equal to the time threshold.
